(19) United States
(12) Patent Application Publication
(10) Pub. No.: US 2010/0050694 A1
(43) Pub. Date: Mar. 4, 2010

(54) BENDING OF GLASS BY HEATED OR COOLED FORM

(75) Inventors: Yannick DAJOUX, La Croix Saint Ouen (FR); Robert Lagneaux, Margny les Compiegne (FR); Gilles Garnier, Dompierre (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 11/556,004

(22) Filed: Nov. 2, 2006

(51) Int. Cl. C03B 23/023

(52) U.S. Cl. 65/106; 65/273

(57) ABSTRACT

The invention relates to a device for bending a glass sheet comprising a bending form, the said form being furnished with means of modifying the temperature (cooling or heating) of its bending surface. The invention in particular provides good stability of the bending conditions while reducing the start-up period.

The invention relates to the bending of glass sheets, particularly for motor vehicle windows, namely in particular their windscreens, side windows or rear windows.

Attempts are always being made to increase the production speeds of bent panes by increasing the travelling speed of glass sheets one after the other in the various production stations, and in particular in at least one bending unit. The sheets may be conveyed for this progression by cushions of air or by beds of rollers. However, the bending tools are generally made of metal and it is not usually recommended to take them to the temperature for bending glass, if their service life is to be preserved. Specifically, it is preferable to heat them to a temperature not exceeding the temperature of irreversible deformation (avoiding the transition into the non-elastic field). In particular, when using an aluminium alloy, it is recommended to keep the bending tools at less than 420° C., usually between 300 and 400° C. The glass, for its part, for this bending operation, must be at its bending temperature, that is to say usually between 600 and 720° C. and even between 650 and 720° C., more generally still between 670 and 710° C. This difference between, on the one hand, the temperature of the glass and, on the other hand, the temperature of the bending tools may lead to the following problems:
at the beginning of manufacture, the temperature of the bending tool increases progressively following the repeated contacts with hotter glass sheets, which progressively modifies the bending parameters (expansion of the tool) and leads to a lack of uniformity of manufacture;
the cooling of the glass in contact with the tool (or the form) increases the difficulty of pronounced curvature (small radii) bends which require more bending time.

The invention solves the abovementioned problems. According to the invention, the bending tool comprises means that can modify its temperature. These means can apply cooling or heating. The tool may also comprise both heating means and cooling means. Depending on the case, these temperature modification means may act locally on the tool or on the whole tool. Thus, the invention relates firstly to a device for bending a glass sheet comprising a bending form, the said form being furnished with means of modifying the temperature of its bending surface. The means of modifying the temperature of the bending surface are usually inside the bending form.

The bending tool comprising means of modifying its temperature may in particular be a full convex form. This full form is usually placed so that its convex bending surface is oriented downwards. This form is associated with a counter-form placed opposite, the glass sheet to be bent being brought between the form and counter-form whose bringing together leads to the glass being pressed to give it the desired curvature. Thus, the form comprising means of modifying its temperature is usually a top full convex form and the counter-form is usually a ring coming into contact with the periphery of the sheet to be bent and not with the central zone. If the form comes into contact with the sheet via a convex surface, the counter-form comes into contact with the sheet via a concave surface, and vice versa. In all cases, the curvatures of the form and of the counter-form are complementary (or matching). Usually, it is not necessary to furnish the counter-form with means modifying its temperature. For the bending operation, the form and the counter-form may move away from or closer to one another, either thanks to the movement of only one of the two, or by the movement of both. Usually, it is sufficient that one of them moves, the other remaining fixed. Usually, the form remains fixed and it is the counter-form that moves. In the most common case, the form is convex, fixed, in the top position (convex face turned downwards) and the counter-form is concave, in the bottom position (concave face turned upwards), placed opposite the convex form, and moves vertically to come closer (to bend the sheet by pressure) or to move away from the top convex form. Thus, the device according to the invention may comprise a counter-form placed opposite the form, means of movement (either of moving closer and further away) allowing the said form and the said counter-form to come together to press the glass sheet between them, and then to separate to release it.

In addition to the means of modifying its temperature, the bending form may comprise means of aspirating a glass sheet, these aspiration means usually being the combination of orifices coming to the surface of its bending face and a pump connected via a duct to these orifices. Thus these aspiration means are capable of keeping the glass sheet from falling when the form is a top form and the counter-form is in the bottom position (at a distance below). This makes it possible to place a cooling medium (usually a ring to carry the glass to the cooling zone) between, on the one hand, the sheet still in contact with the top form and, on the other hand, the bottom counter-form. Stopping the aspiration through the top form leads to the bent form falling onto the cooling medium, which then carries away the said sheet to the cooling zone. This cooling may be of the tempering (or hardening) type (preferably for motor vehicle windows or rear windows) or natural cooling (preferably for windscreens).

Usually, the time of contact between the glass sheet and the bending form is from 1.3 to 3.5 seconds.

Cooling of the bending form is required essentially in order to stabilize this form, with respect to its temperature and its geometry, in order to ensure a good reproducibility of the curve conferred on the glass sheets from the beginning of a production run. This cooling may in particular be applied by the circulation of a cooling fluid through ducts inside the form. This fluid may be water. It may be water originating directly from the town mains whose temperature is usually from 5 to 15° C. (qualified as cold water). The cooling fluid may also be independent of an external system and be installed in a closed and recycled circuit, the temperature being kept sufficiently cold thanks to a regulation device. Thus, by running through this closed circuit, the water traverses the bending form, then the regulation device, then returns to the bending form and so on. The contact of the cooled form with the glass leads to a more rapid cooling of the glass without it disrupting the bending. The bending process is never in balance with respect to the temperatures (furthermore, it must never be, since the temperatures of the glass and of the bending form must be different), but it has been established that it is possible to cause it to operate dynamically at high rates to produce batches of very uniform bent sheets. It is possible to achieve rates of less than 13 seconds, even of the order of 10 seconds (the time elapsing between one sheet being replaced by another, for the same instant of the transformation). Tests have shown that the form could be at 10° C. at the beginning of production, then, at the permanent rate, approaching 80° C. These two temperatures are in fact very close and do not cause any inconvenient differences of geometry (due to expansion). These results were obtained with a Forthal HR aluminium alloy form. This more rapid cooling of the glass following the contact with the cooled form makes it possible to solidify it rapidly so that it deforms no more when it falls on the cooling ring. The bending unit comprising the cooled form may be placed in an oven (temperature between 600 and 720° C., usually approximately 650° C.) or, preferably in the ambient air, in no enclosure.

Bending with the aid of a cooled form is particularly suitable for bent glass with bending tools placed in an oven. These panes are then usually tempered.

Instead of the form being cooled, it can be heated. Heating will preferably be applied when the bend is complex and/or particularly pronounced. Complex bending means significant bending in all directions (those skilled in the art speak of bending and cross-bending). Pronounced bending means either the production of short curvature radii (which is the equivalent of a pronounced curvature), for example less than 200 mm and even less than 100 mm, or a particularly high deflexion, for example more than 40 mm and even more than 55 mm. Thus, the bending form may comprise a curvature radius of less than 200 mm, even of less than 100 mm or a deflexion of more than 40 mm, even of more than 55 mm.

The heating means are placed close to the zones of the bending surface with more pronounced curvatures. The heating is usually applied by electric resistances placed inside the bending form, in the more awkward zones to be bent (small radii or to prevent undulations in the corners when the curvatures are antagonistic due to their non-parallel directions). The local application of heating locally lowers the viscosity of the glass which then flows more easily to follow the curvatures imposed thereupon. The additional heating gives the time necessary for the forming. For example, the heated form may have at least locally at the surface a temperature of between 300 and 400° C. The heated form is part of a bending unit (comprising form and counter-form). The bending unit comprising the heated form may be placed in an oven (temperature between 600 and 720° C., usually approximately 650° C.) or, preferably in the ambient air, in no enclosure (“cold process”). The form therefore loses calories in contact with the ambient air, so that its temperature achieves a balance. As in the case of the cooled forms, the heated forms make it possible to counteract the disadvantage of the gradual start-up. Specifically, since the form is heated to a reasonable degree from the beginning, the repeated contact of the glass sheets brings only relatively few calories so that the temperature of the form does not really increase significantly. In addition, the heating of the form is regulated, and it will automatically contribute fewer calories if the form receives them via the glass sheets. The temperature of the form nevertheless remains below the glass deformation temperature and the glass arriving much hotter cools all the same in contact with the heated form. Relative to the case of the cooled form, the user will usually have to wait longer before allowing the sheet to fall onto the cooling medium so that the sheet is more solidified and less subject to marking when falling onto the said medium. Bending via a heated form allows a regulation of the temperature of the said form to be part of a bending unit not placed in an oven. After bending, the glass is not usually tempered and may, for example, be incorporated into a laminated glazing unit.

The method according to the invention is particularly suitable for operating in the ambient air (ambient air temperature of less than 50° C.), only the bending forms being “heating” or “cooling”. Those skilled in the art speak of “cold process” due to the absence of a heated enclosure (that is to say an oven).

Usually, the form and the counter-form are covered in felt or cloth or knit (of metal and/or ceramic fibres) to soften the contact with the glass sheet and reduce marking.

The form may comprise both heating means and cooling means, which makes it possible to combine the advantages of these two types of means. The heating means will be placed in the locations of more pronounced curvature and the cooling means will preferably be placed towards the central part. The cooling means provide great stability (that is to say reproducibility) of the curve (that is to say geometry) of the bent sheets from the beginning of production and with no start-up phase, and the heating parts make it possible to form deeper curves (more pronounced curvatures).

The invention is suitable for the bending of any thickness of glass sheet, more particularly of glass sheets from 1.8 to 10 mm thick. In particular, the heating form is very well suited to the forming of thin sheets (1.8 to 2.8 mm thick).

The invention also makes it possible to bend simultaneously at least two glass sheets placed one on top of the other. This makes it possible to prepare panes with virtually identical curvatures, fitting very well into a laminated glazing unit. Remember that the various bent panes of a laminated glazing unit are separated by a sheet of a polymer such as polyvinylbutyral (PVB).

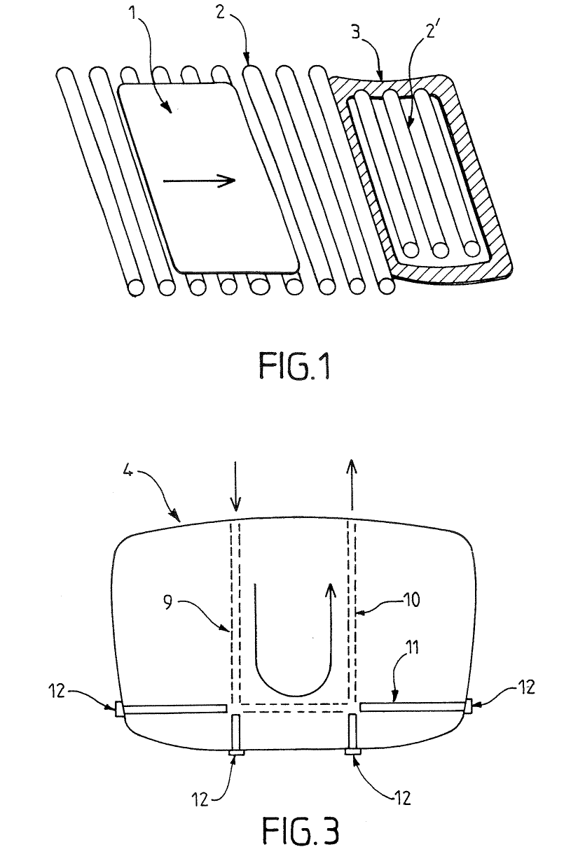

FIG. 1 represents a part of a bending unit that may be used in the context of the present invention. The hot flat glass sheet 1 is conveyed by the roller bed 2 in the direction of the arrow towards the bending unit whereof only the bottom counter-form 3 consisting of a (continuous) bending ring has been shown. This concave ring is shown in the low position, that is to say at a level slightly lower than the conveyance plane so that the glass sheet can correctly pass over it. Rollers 2′ shorter than the rollers 2 are inside the ring but clearly form part of the conveyance bed and are on the same plane as the rollers 2. These rollers 2′ are shorter so as not to hamper the vertical movements of the ring 3. When the sheet is in the correct position over the ring 3, the ring moves vertically upwards to press the sheet against the top convex form (heated or cooled) (not shown) and bend it.

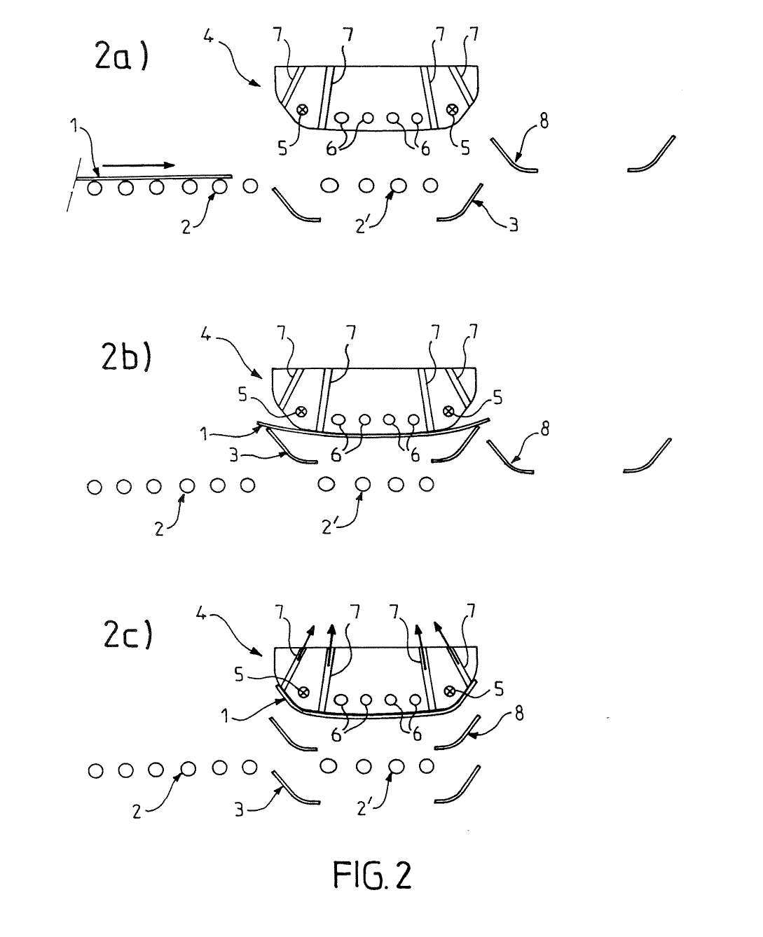

FIG. 2 represents the bending process according to the invention. The top convex form 4 is fixed relative to the counter-form 3 in the low position 2a). The form 4 contains both heating means 5 (electric resistances) and cooling means 6 that are ducts through which cold water flows. The resistances 5 are placed close to the locations of more awkward pronounced curvature to be bent. Naturally, it is also possible to produce a form either with heating means only or with cooling means only. The form 4 also comprises orifices opening onto the convex bending surface, these orifices being connected to pumping means. In FIG. 2a, a sheet 1 is approaching the bending unit, the counter-form 3 is in the low position and the cooling medium 8 is in the waiting position on the side. In FIG. 2b, the sheet 1 is being bent between the counter-form 3 which rises to press it against the convex bending surface of the form 4. In FIG. 2c, the counter-form 3 has returned to the low position but the sheet 1 remains stuck after bending thanks to the aspiration applied through the orifices 7. The cooling ring 8 has come to place itself beneath the sheet to receive it when the aspiration stops. The sheet will then be carried away on the medium 8 to the right to undergo the required cooling (tempering, semi-tempering or natural cooling).

FIG. 3 shows how it is possible to produce a circulation of water through a full metal form 4 seen from the side of its bending surface. Three drillholes 9, 10 and 11 have been made passing totally from one side to the other of the form 4, these drillholes intersecting. It is then sufficient to plug a portion of these orifices with plugs 12 so that the water takes the route indicated by the arrows. Naturally, longer and more complex circulation systems may be produced as appropriate in another manner.

1. Device for bending a glass sheet comprising a bending form wherein the said form is furnished with means of modifying the temperature of its bending surface.

2. Device according to claim 1, wherein the said means are inside the said form.

3. Device according to claim 1, wherein the said means are cooling means.

4. Device according to claim 3, wherein the said means are ducts through which a cooling fluid travels.

5. Device according to claim 4, wherein the fluid is water.

6. Device according to claim 1, wherein the said means are heating means.

7. Device according to claim 6, wherein the said means are electric resistances.

8. Device according to claim 6, wherein the said means are placed close to the zones of the bending surface with more pronounced curvatures.

9. Device according to claim 6, wherein the form comprises a curvature radius of less than 200 mm or a flex of more than 40 mm.

10. Device according to claim 9, wherein the form comprises a curvature radius of less than 100 mm or a flex of more than 55 mm.

11. Device according to claim 1, wherein the form is a full convex form.

12. Device according to claim 1, wherein it comprises a counter-form placed opposite the form, means of movement allowing the said form and the said counter-form to come together to press the glass sheet between them.

13. Device according to claim 12, wherein the counter-form is a ring.

14. Device according to claim 1, wherein it is in the ambient air.

15. Method of bending a glass sheet by a device for bending a glass sheet comprising a bending form wherein the said form is furnished with means of modifying the temperature of its bending surface.

16. Method according to claim 15, wherein the time of contact between the glass sheet and the bending form is from 1.3 to 3.5 seconds.

17. Method according to claim 15, wherein the time of production is less than 13 seconds.

18. Method according to claim 15, wherein the sheet is from 1.8 to 2.8 mm thick.
